(19) United States
(12) Patent Application Publication
(10) Pub. No.: US 2019/0347295 A1
(43) Pub. Date: Nov. 14, 2019

(54) DISPLAY APPARATUS AND DISPLAY METHOD

(71) Applicant: FUJITSU LIMITED, Kawasaki-shi (JP)

(72) Inventors: Takuma Okuda, Kawasaki (JP); Wei Zhu, Edogawa (JP); Sanae Shoda, Ota (JP)

(73) Assignee: FUJITSU LIMITED, Kawasaki-shi (JP)

(21) Appl. No.: 16/406,223

(22) Filed: May 8, 2019

(30) Foreign Application Priority Data
May 14, 2018 (JP) 2018-093380

(51) Int. Cl. G06F 16/901; G06F 16/903

(52) U.S. Cl. CPC G06F 16/9017; G06F 16/90335

(57) ABSTRACT

A display apparatus includes a memory configured to store a plurality of articles and a processor configured to, in response to receiving a selection of a first type of industry, extract a first plurality of articles relating to the first type of industry by reference to the plurality of articles stored in the memory, calculate a relevance value between each of a plurality of keywords included in the first plurality of articles and the first type of industry, and display an image including the plurality of keywords at positions determined based on the calculated relevance value.

### CROSS-REFERENCE TO RELATED APPLICATION

This application is based upon and claims the benefit of priority of the prior Japanese Patent Application No. 2018-93380, filed on May 14, 2018, the entire contents of which are incorporated herein by reference.

### FIELD

The embodiments discussed herein are related to a display technology.

### BACKGROUND

Before a visit to a company for corporate sales, news, for example, regarding a type of industry to which the company belongs to may be collected and grasped from news sites on the Web by entering a specific keyword to a search engine to search the news. International Publication Pamphlet No. WO 2008/139568 discusses a related art, for example.

### SUMMARY

According to an aspect of the embodiments, a display apparatus includes a memory configured to store a plurality of articles and a processor configured to, in response to receiving a selection of a first type of industry, extract a first plurality of articles relating to the first type of industry by reference to the plurality of articles stored in the memory, calculate a relevance value between each of a plurality of keywords included in the first plurality of articles and the first type of industry, and display an image including the plurality of keywords at positions determined based on the calculated relevance value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a configuration of a display apparatus according to an embodiment;

FIG. 2 is a diagram illustrating an example of a keyword table;

FIG. 3 is a diagram illustrating an example of a type-of-industry selection screen;

FIG. 4 is a diagram illustrating an example of a keyword selection screen;

FIG. 5 is a diagram illustrating an example of a search result display screen;

FIG. 6 is a diagram illustrating an example of a bookmark list screen;

FIG. 7 is a diagram for explaining model learning;

FIG. 8 is a flowchart illustrating an example of display processing according to an embodiment; and

FIG. 9 is a diagram illustrating an example of a computer that executes a display program.

### DESCRIPTION OF EMBODIMENTS

According to the technology in the past, it may be difficult to efficiently search information for each of types of industry. Generally, news on a news site is not categorized into types of industry. In order to find news relating to a specific type of industry by searching, it is important for a user to consider a search word by himself or herself. The quality of the obtained information and the efficiency of the search works depend on the search skill of the user.

Embodiments of a display program, a display method and a display apparatus will be described in detail below with reference to drawings. The disclosed technology is not limited by the embodiments. The following embodiments may be combined to the extent not inconsistent with each other.

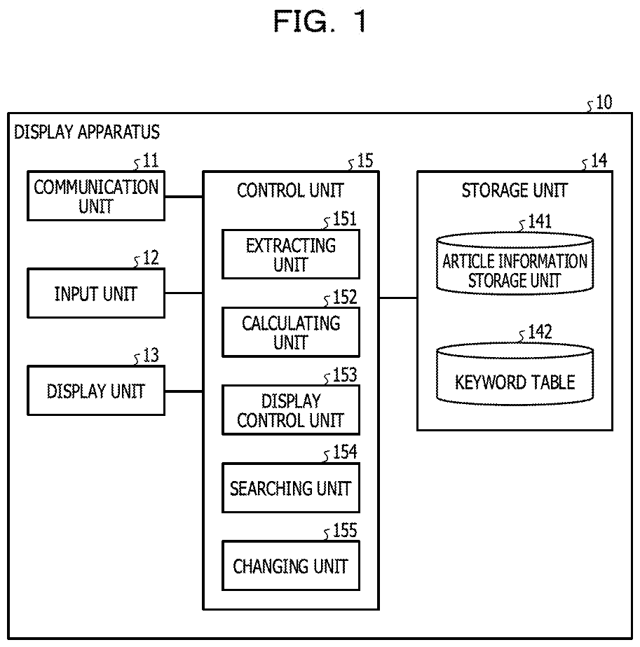

A configuration of a display apparatus 10 will be described with reference to FIG. 1. FIG. 1 is a block diagram illustrating an example of a configuration of a display apparatus according to an embodiment. As illustrated in FIG. 1, the display apparatus 10 includes a communication unit 11, an input unit 12, a display unit 13, a storage unit 14, and a control unit 15. The display apparatus 10 may include functional units such as an input device and an audio output device which are included in a known computer other than the functional units illustrated in FIG. 1.

The communication unit 11 is implemented by a network interface card (NIC), for example. The communication unit 11 is a communication interface responsible for communication of information to and from another apparatus connected thereto in a wired or wireless manner over a network.

The input unit 12 is an input device that is to be used to input information to the display apparatus 10. The input unit 12 corresponds to a keyboard, a mouse, a touch panel or the like. The display unit 13 is a display apparatus that displays information. The display unit 13 displays information output from the control unit 15. The display unit 13 corresponds to a display apparatus such as a liquid crystal display or a touch panel.

The storage unit 14 is implemented by a storage device such as a random access memory (RAM), a semiconductor memory element such as a flash memory, a hard disk, or an optical disk. The storage unit 14 has an article information storage unit 141 and a keyword table 142. The storage unit 14 stores information for use in processing by the control unit 15.

The article information storage unit 141 stores, as an article information piece, information regarding an article provided by a news site or a newspaper publishing company over the Internet. It is assumed that the article information pieces stored in the article information storage unit 141 are classified into types of industry in advance. Each of the article information pieces includes a title of the article, descriptions, a source and a date and time when the article information piece is provided.

The classification of articles in the article information storage unit 141 may be performed manually or automatically. For example, articles may be classified into types of industry based on scores in relevance between the articles and the types of industry. The article classification in the article information storage unit 141 may be performed by using a classification model which has learned based on results of manual classifications.

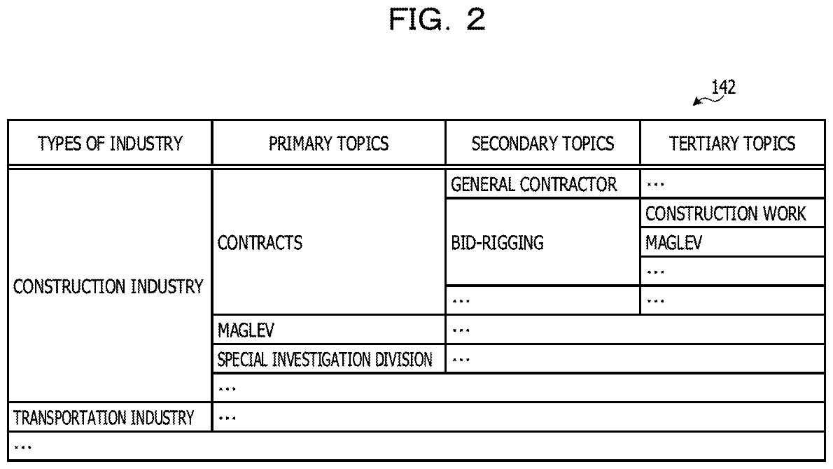

The keyword table 142 stores keywords for each of the types of industry. FIG. 2 is a diagram illustrating an example of the keyword table. As illustrated in FIG. 2, the keyword table 142 has items “types of industry”, “primary topics”, “secondary topics”, and “tertiary topics”.

The primary topics, the secondary topics, and the tertiary topics represent keywords relating to the types of industry. Each of the keywords is set manually or automatically in processing which will be described below. Keywords being the primary topics have the highest relevance to the corresponding type of industry. Keywords being the secondary topics are related to the keywords being the primary topics. Keywords being the tertiary topics are related to the keywords being the secondary topics.

For example, in the example in FIG. 2, the keyword table 142 stores “contracts”, “maglev”, and “special investigation division” as keywords being the primary topics relating to the construction industry. The keyword table 142 further stores “general contractor” and “bid-rigging” as keywords being the secondary topics relating to the keyword “contracts” being the primary topic. The keyword table 142 further stores “construction work” and “maglev” as keywords being the tertiary topics relating to the keyword “bid-rigging” being the secondary topic.

Referring back to FIG. 1, the control unit 15 is implemented by a program stored in an internal storage device, including a plurality of instructions and executed by a central processing unit (CPU), a micro processing unit (MPU) or the like by using a RAM as a work area, for example. The control unit 15 may be implemented by an integrated circuit such as an application specific integrated circuit (ASIC) or a field programmable gate array (FPGA). The control unit 15 has an extracting unit 151, a calculating unit 152, a display control unit 153, a searching unit 154, and a changing unit 155 and implements or executes functions and actions of information processing which will be described below. The internal configuration of the control unit 15 is not limited to the configuration illustrated in FIG. 1 but may be other configurations if the information processing which will be described below may be implemented.

In a case where a selection of a type of industry is received, the extracting unit 151 extracts article information pieces relating to the received type of industry with reference to the article information storage unit 141 that stores a plurality of article information pieces. The article information storage unit 141, as described above, stores article information pieces classified into types of industry. Thus, the extracting unit 151 may extract article information pieces relating to a specific type of industry.

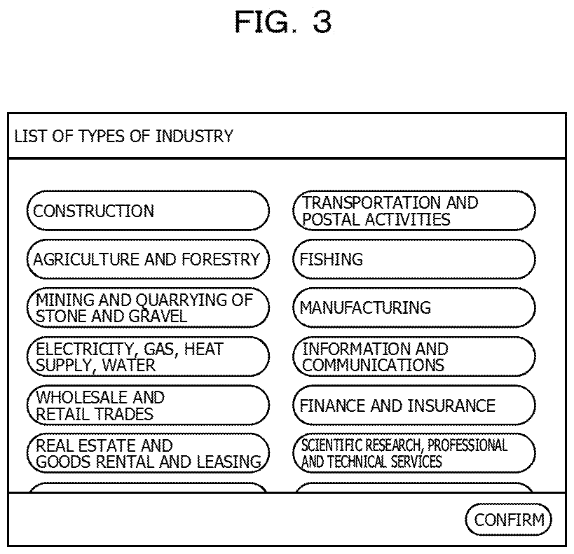

The selection of a type of industry is received through a type-of-industry selection screen displayed on the display unit 13 under control of the display control unit 153. FIG. 3 is a diagram illustrating an example of the type-of-industry selection screen. As illustrated in FIG. 3, the type-of-industry selection screen displays a list of preset types of industry. The types of industry displayed on the type-of-industry selection screen may be types of industry registered with the keyword table 142.

The calculating unit 152 calculates a relevance ratio of each of keywords included in the extracted article information pieces to the type of industry. For example, the calculating unit 152 may handle a ratio of the number of articles including a certain keyword to a total number of article information pieces extracted by the extracting unit 151 as the relevance ratio of the keyword. In this case, the calculating unit 152 stores a keyword having a relevance ratio equal to or higher than a predetermined value as a primary topic in the keyword table 142.

In a case where the ratio of the number of articles including a certain keyword to the total number of articles including the keyword being the primary topic is equal to or higher than a predetermined value, the calculating unit 152 stores the keyword as a secondary topic in the keyword table 142. Also, the calculating unit 152 may store a keyword being a tertiary topic in the keyword table 142. According to this embodiment, a model having search keywords for each of types of industry like the keyword table 142 will be called an industry-wise trend word model.

For example, it is assumed that the number of article information pieces relating to the construction industry, which are extracted by the extracting unit 151, is equal to 100. It is also assumed that, as a result of the relevance ratio calculation, the calculating unit 152 stores in the keyword table 142 a keyword having a relevance ratio equal to or higher than 0.2. It is further assumed that each article information piece includes one article.

In a case where 25 articles of the extracted 100 article information pieces include the keyword “contracts”, the relevance ratio of the keyword “contracts” to the construction industry is 0.25. As a result, the calculating unit 152 stores the keyword “contracts” in the keyword table 142 as a primary topic.

Furthermore, when the 25 articles including the keyword “contracts” include 10 articles including a keyword “bid-rigging”, the relevance ratio of the keyword “bid-rigging” to the keyword “contracts” being the primary topic is 0.4. As a result, the calculating unit 152 stores the keyword “bid-rigging” in the keyword table 142 as a secondary topic under “contracts”.

The display control unit 153 causes the display unit 13 to display, as the keyword selection screen, an image having keywords at different positions based on their calculated relevance ration with respect to a word representing a type of industry. The display control unit 153 causes the display unit 13 to display the image based on the keyword table 142. Addition and deletion of a keyword may be received by the changing unit 155, which will be described below, to update the keyword table 142. In this case, the display control unit 153 causes the display unit 13 to display the image having keywords based on the at least one of keyword addition and deletion received by the changing unit 155.

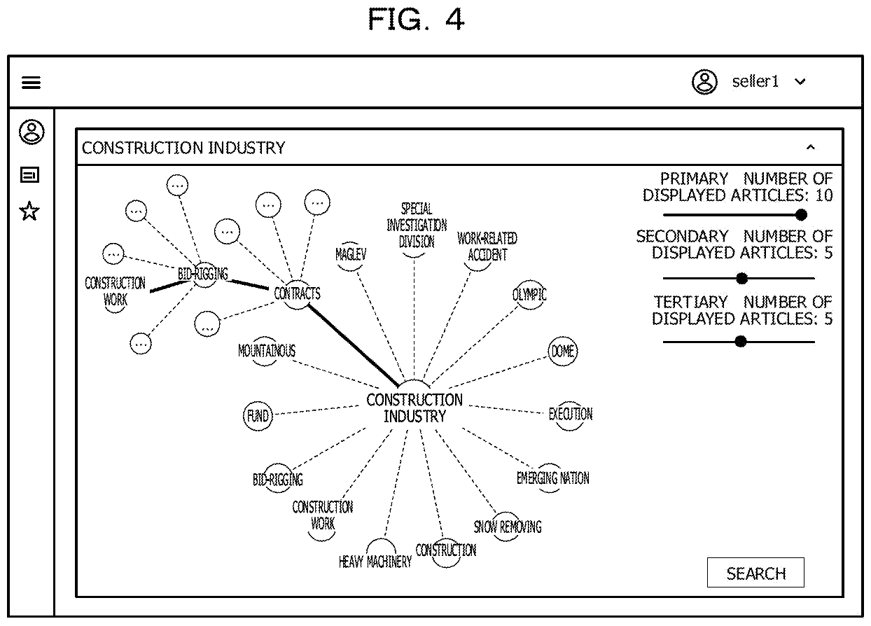

FIG. 4 is a diagram illustrating an example of the keyword selection screen. As illustrated in FIG. 4, the keyword selection screen has keywords being the primary topics around a word representing a type of industry. The keyword selection screen further has keywords being secondary topics around a keyword selected from the keywords being the primary topics. The keyword selection screen further has keywords being tertiary topics around the keyword selected from the keywords being the secondary topics.

In the example in FIG. 4, the word representing a type of industry is “construction industry”, and “contracts” is selected from the keywords being the primary topics. Furthermore, “bid-rigging” is selected from the keywords being the secondary topics under “contracts”.

Based on the keywords and a word analogous to the keywords displayed by the display control unit 153, the searching unit 154 searches article information pieces corresponding to the keywords and the word analogous to the keywords through the article information storage unit 141. For example, the searching unit 154 performs the search by using the keywords “contracts”, “bid-rigging”, and “construction work” selected on the keyword selection screen and a keyword “collusion” analogous to “bid-rigging”. It is assumed that such an analogous keyword is preset by using a dictionary and open data.

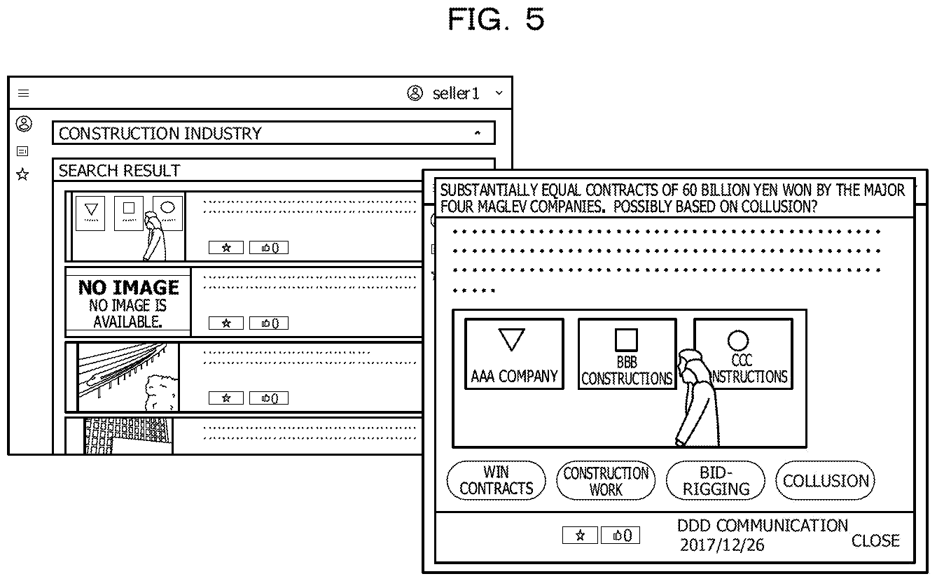

The display control unit 153 causes the display unit 13 to display a search result display screen having a result of the search by the searching unit 154. FIG. 5 is a diagram illustrating an example of the search result display screen. As illustrated in FIG. 5, the search result display screen displays a list of article information pieces corresponding to the search result. When an article information piece is selected from the list, the search result display screen further displays details of the selected article information piece. The search result display screen further displays keywords used for the search.

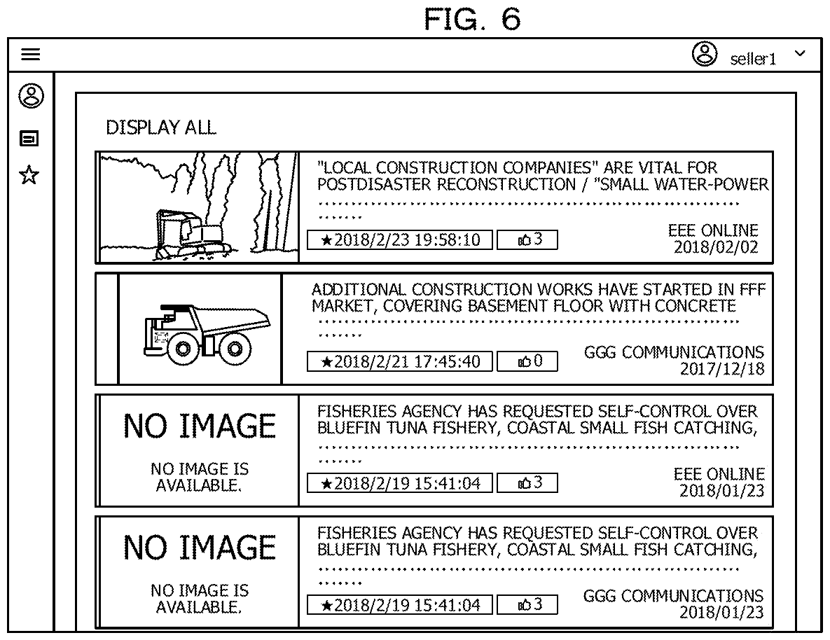

The searching unit 154 may save an article information piece corresponding to the search result as a bookmark in accordance with a selection by a user. FIG. 6 is a diagram illustrating an example of a bookmark list screen. As illustrated in FIG. 6, the display control unit 153 may display on the bookmark list screen an article information piece, or a bookmark, searched by the searching unit 154 and selected by a user.

The display control unit 153 may further display an article information piece acquired by filtering an article information piece selected by a user by using a word representing a type of industry from a plurality of article information pieces searched and identified by the searching unit 154. For example, even in a case where one user has saved, as bookmarks, results of searches for both of article information pieces relating to the construction industry and article information pieces relating to the transportation industry, the filtering by using a type of industry may be performed thereon and the resulting bookmarks may be shared with another terminal.

The display control unit 153 causes the display unit 13 to display a predetermined article information piece selected by a user from a plurality of article information pieces searched and identified by the searching unit 154 along with the number of times that the article information piece has been appreciated. For example, when a user who has searched article information pieces and a user who shares the bookmarks select (or put “like” on) an article information piece that they like, the result of their selections (such as the number of “likes”) of the article information piece is displayed on all of terminals of users who share the article information piece.

The changing unit 155 changes the keyword table 142 so that the industry-wise trend word model is caused to learn. For example, the changing unit 155 receives addition and deletion of a keyword. As described above, the changing unit 155 updates the keyword table 142 based on the received keyword addition and deletion. The changing unit 155 enables to manually cause the industry-wise trend word model according to this embodiment to forcibly learn.

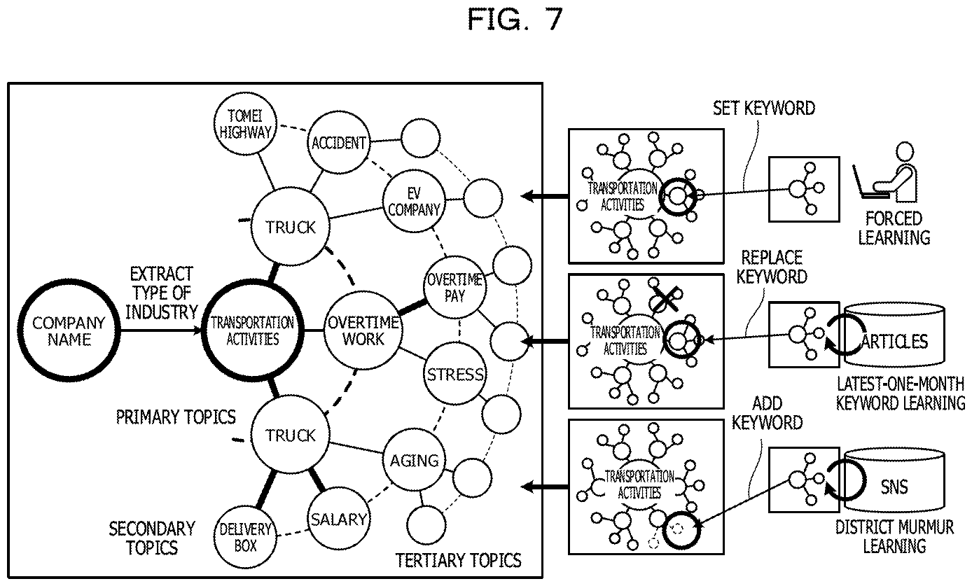

FIG. 7 is a diagram for explaining the model learning. As illustrated in FIG. 7, the changing unit 155 may cause not only the manual forced learning but also automatic learning. For example, the changing unit 155 may collect article information pieces within the latest one month and replace the keywords in the keyword table 142 based on the collected article information pieces. Also, for example, the changing unit 155 may add a keyword to the keyword table 142 based on murmurs in a predetermined district which are collected from an SNS.

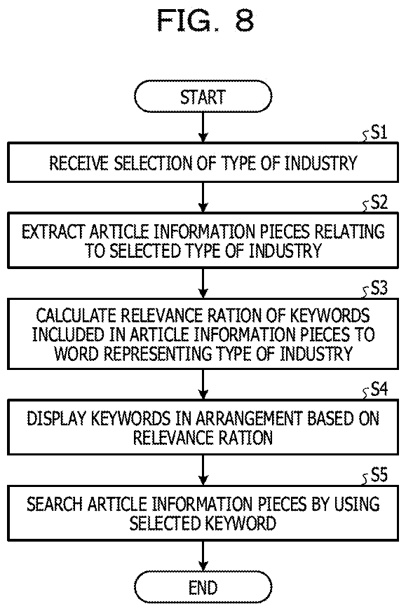

Next, operations by the display apparatus 10 according to an embodiment will be described. FIG. 8 is a flowchart illustrating an example of display processing according to an embodiment.

As illustrated in FIG. 8, the display apparatus 10 receives a selection of a type of industry through the type-of-industry selection screen (step S1). Next, the display apparatus 10 extracts article information pieces relating to the selected type of industry from the article information storage unit 141 (step S2). The display apparatus 10 calculates relevance ration of keywords included in the article information pieces to a word representing the type of industry (step S3). The display apparatus 10 stores in the keyword table 142 a result of the keyword extraction and a result of the relevance ratio calculation.

The display apparatus 10 displays the keywords in an arrangement based on the relevance ration on the keyword selection screen with reference to the keyword table 142 (step S4). The display apparatus 10 searches article information pieces by using a keyword selected on the keyword selection screen and displays a search result display screen (step S5).

The display apparatus 10 may perform the processing in step S2 and step S3 at a time different from the time of the processing in the other steps. For example, the display apparatus 10 may perform the processing in step S2 and step S3 in advance so that the keyword table 142 may be generated in advance. In this case, when receiving a selection of a type of industry through the type-of-industry selection screen (step S1), the display apparatus 10 may display the keyword selection screen with reference to the keyword table 142 (step S4) without performing the processing in step S2 and step S3 again.

In this manner, when receiving a selection of a type of industry, the display apparatus 10 extracts article information pieces relating to the received type of industry with reference to the storage unit 14 that stores a plurality of article information pieces. The display apparatus 10 further calculates a relevance ratio of each of keywords included in the extracted article information pieces to the type of industry. The display apparatus 10 displays an image having the keywords at different positions based on the calculated relevance ration with respect to the word representing the type of industry. As a result, the work for searching information for each of types of industry by a user can be aided.

Based on a keywords and a word analogous to the keyword, the display apparatus 10 searches article information pieces corresponding the keyword and the word analogous to the keywords from the article information storage unit 141. As a result, the user can increase the search hit rate.

The display apparatus 10 receives addition and deletion of a keyword and displays an image having keywords arranged based on the received keyword addition and deletion. As a result, a user may reflect, to the article information search model, information that is difficult to automatically reflect such as company know-hows.

The display apparatus 10 further displays an article information piece acquired by filtering an article information piece selected by a user by using a word representing a type of industry from a plurality of searched and identified article information pieces. As a result, a plurality of users may share article information pieces relating to a certain type of industry in the selected article information pieces.

The display apparatus 10 displays an article information piece selected by a user from a plurality of searched and identified article information pieces along with the number of times that the article information piece has been appreciated. As a result, a plurality of users may share information regarding appreciation for and usefulness of the article information piece.

According to the aforementioned embodiment, the display apparatus 10 searches by using keywords of three levels from a primary topic to a tertiary topic. However, embodiments are not limited thereto. For example, a user may arbitrarily set the number of topic levels for each searching operation.

The components of the illustrated units may not physically be configured as illustrated. In other words, for example, the concrete forms of distributions and integrations of the units are not limited to those illustrated in drawings, and all or a part of the units may be distributed and integrated functionally or physically in arbitrary units. For example, the extracting unit 151 and the calculating unit 152 in the display apparatus 10 may be integrated. The illustrated processes are not limited to execution in the aforementioned order but may be executed simultaneously or in changed order to the extent that details of the processes are not inconsistent with each other.

Furthermore, all or an arbitrary part of the processing functions executed by the apparatuses may be executed on a CPU (or a microcomputer such as an MPU or a micro controller unit (MCU)). All or an arbitrary part of the processing functions may be executed on a program to be analyzed and executed by a CPU (or a microcomputer such as an MPU or a MCU) or on hardware by wired logic.

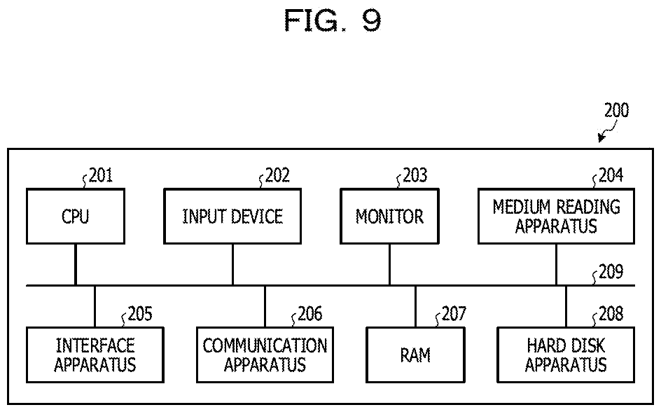

The processes according to the aforementioned embodiments may be implemented by a program prepared in advance and executed by a computer. An example of the computer that executes the program having the same functions as the aforementioned embodiments will be described below. FIG. 9 is a diagram illustrating an example of a computer that executes a display program.

As illustrated in FIG. 9, a computer 200 includes a CPU 201 configured to execute computing processes, an input device 202 configured to receive a data input, and a monitor 203. The computer 200 further includes a medium reading apparatus 204 configured to read a program from a storage medium, an interface apparatus 205 connected to apparatuses, and a communication apparatus 206 connected to an information processing apparatus and so on in a wired or wireless manner. The computer 200 further includes a RAM 207 configured to temporarily store information and a hard disk apparatus 208. The apparatuses 201 to 208 are connected to a bus 209.

The hard disk apparatus 208 stores a display program having the same functions as those of the processing units of the extracting unit 151, the calculating unit 152, the display control unit 153, the searching unit 154 and the changing unit 155 illustrated in FIG. 1. The hard disk apparatus 208 further stores data that implement the storage unit 14.

The input device 202 receives inputs of information such as operation information from a manager of the computer 200, for example. The monitor 203 displays screens such as an output screen to the manager of the computer 200, for example. A printing apparatus, for example, is connected to the interface apparatus 205. The communication apparatus 206 is connected to the other apparatuses over a network to exchange information.

The CPU 201 reads out programs each including a plurality of instructions stored in the hard disk apparatus 208 and decompresses and executes them in the RAM 207 to perform corresponding processes. These programs may cause the computer 200 to function as the extracting unit 151, the calculating unit 152, the display control unit 153, the searching unit 154 and the changing unit 155 illustrated in FIG. 1.

The display program may not be stored in the hard disk apparatus 208. For example, the computer 200 may read out and execute the program stored in a storage medium that may be read by the computer 200. The storage medium that may be read by the computer 200 corresponds to, for example, a portable recording medium such as a CD-ROM, a digital versatile disc (DVD), a universal serial bus (USB) memory, a semiconductor memory such as a flash memory, or a hard disk drive. The display program may be stored in an apparatus connected to a public network, the Internet, a LAN or the like, and the computer 200 may read out and execute the display program from the network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A display apparatus comprising:
a memory configured to store a plurality of articles; and
a processor coupled to the memory and the processor configured to
in response to receiving a selection of a first type of industry, extract a first plurality of articles relating to the first type of industry by reference to the plurality of articles stored in the memory,
calculate a relevance value between each of a plurality of keywords included in the first plurality of articles and the first type of industry, and
display an image including the plurality of keywords at positions determined based on the calculated relevance value.

2. The display apparatus according to claim 1, wherein the relevance value is a ratio of a number of articles including each of the plurality of keywords to a number of articles of the first plurality of articles.

3. The display apparatus according to claim 1, wherein the processor is configured to, based on a first keyword of the plurality of keywords and a first word analogous to the first keyword, perform a search for an article relating to at least one of the first keyword and the first word through the plurality of articles.

4. The display apparatus according to claim 1, wherein the processor is configured to, in a case where a change instruction including at least one of addition of a keyword and deletion of a keyword to and from the plurality of keywords is received, change the plurality of keywords in accordance with the change instruction.

5. The display apparatus according to claim 3, wherein the processor is configured to display an article acquired by filtering, by using a word representing the first type of industry, one or more articles selected by a user from a second plurality of articles identified by the search.

6. The display apparatus according to claim 3, wherein the processor is configured to display one or more articles selected by a user from a second plurality of articles identified by the search in association with a number of times that the one or more articles have been evaluated.

7. A computer-implemented display method comprising:
in response to receiving a selection of a first type of industry, extracting a first plurality of articles relating to the first type of industry by reference to a plurality of articles stored in a memory;
calculating a relevance value between each of a plurality of keywords included in the first plurality of articles and the first type of industry; and
displaying an image including the plurality of keywords at positions determined based on the calculated relevance value.

8. The display method according to claim 7, wherein the relevance value is a ratio of a number of articles including each of the plurality of keywords to a number of articles of the first plurality of articles.

9. The display method according to claim 7, further comprising: based on a first keyword of the plurality of keywords and a first word analogous to the first keyword, performing a search for an article relating to at least one of the first keyword and the first word through the plurality of articles.

10. The display method according to claim 7, further comprising: in a case where a change instruction including at least one of addition of a keyword and deletion of a keyword to and from the plurality of keywords is received, changing the plurality of keywords in accordance with the change instruction.

11. The display method according to claim 9, further comprising:
displaying an article acquired by filtering, by using a word representing the first type of industry, one or more articles selected by a user from a second plurality of articles identified by the search.

12. The display method according to claim 9, further comprising:
displaying one or more articles selected by a user from a second plurality of articles identified by the search in association with a number of times that the one or more articles have been evaluated.

13. A non-transitory computer-readable medium storing instructions executable by one or more computers, the instructions comprising:
one or more instructions for, in response to receiving a selection of a first type of industry, extracting a first plurality of articles relating to the first type of industry by reference to the plurality of articles stored in the memory;
one or more instructions for calculating a relevance value between each of a plurality of keywords included in the first plurality of articles and the first type of industry; and
one or more instructions for displaying an image including the plurality of keywords at positions determined based on the calculated relevance value.
